(19) United States
(12) Patent Application Publication
(10) Pub. No.: US 2012/0191929 A1
(43) Pub. Date: Jul. 26, 2012

(54) METHOD AND APPARATUS OF RAPIDLY DEPLOYING VIRTUAL MACHINE POOLING VOLUME

(75) Inventors: William ZIETZKE, Covington, WA (US); Yoshiki KANO, Bellevue, WA (US); Dan RITCHIE, Issaquah, WA (US); Fumimasa NAKANE, Redmond, WA (US); Hiromichi OTA, Redmond, WA (US)

(73) Assignee: HITACHI, LTD., Tokyo (JP)

(21) Appl. No.: 13/011,138

(22) Filed: Jan. 21, 2011

(51) Int. Cl. G06F 12/02; G06F 12/16

(52) U.S. Cl. 711/162; 711/171; 711/E12.002; 711/E12.103

(57) ABSTRACT

Exemplary embodiments provide rapid creation and deployment of virtual machines by reducing communication processes between virtual machine user and storage and server administrators. One embodiment is a method for deploying virtual machines of host computers. A storage subsystem provides a pool of pre-created virtual volumes in the storage subsystem prior to deploying the virtual machines, the pre-created virtual volumes having pre-copied images for the virtual machines. The method comprises: selecting one of the pre-created virtual volumes for deploying one of the virtual machines; calculating a volume size for the selected virtual volume based on a specified image size for data and OS image; resizing the selected virtual volume according to the calculated volume size; and requesting one of the host computers to deploy the virtual machine using the resized virtual volume.

### BACKGROUND OF THE INVENTION

The present invention relates generally to storage systems and, more particularly, the rapid deployment of virtual machine pooling volume.

In a datacenter, the creation and deployment process for virtual machine using a volume on an external subsystem is a time consuming process. A typical procedure involves the following: (1) The virtual machine (VM) user asks the storage administrator to create a volume based on size. (2) The VM user asks the server administrator to discover the created volume on operation. (3) The server administrator discovers the created volume for the target hypervisor on the host. (4) The VM user copies VM images data such as VHD file on the discovered volume (e.g., in Windows Hyper-V world). (5) The VM user runs the image data on the hypervisor. In the copying of VM images data (4), if GUID (globally unique identifier) is duplicated among volumes, some failover clusters keep a state for the duplicated signature disk as reserved disk.

U.S. Pat. No. 7,555,644 for system and method for operating system image provisioning in a utility computing environment discloses a technique for provisioning OS image a boot up of a computing server using a pool for OS image copied volume. FIG. 1 of that patent shows a procedure of managing the pool based on upper and lower numbers of OS image Boot-up disks as pool threshold. However, that patent does not disclose how to achieve efficient pool management based on customer creation usage and the OS image boot-up disk is fixed in size. The method is not for virtual machine. The VM user cannot select the desired size boot image. Therefore, that patent improves (2), (3), and (4) which we mentioned as customer operation, but not size operation, and it also does not provide efficient control of the pool availability.

### BRIEF SUMMARY OF THE INVENTION

Exemplary embodiments of the invention provide method and apparatus for rapid creation and deployment of virtual machines by reducing or minimizing communication processes between virtual machine user and storage and server administrators. In specific embodiments, the rapid VM creation and deployment method involves the use of an external storage subsystem. The system management server prepares a pool of pre-created virtual volumes with pre-copied images controlling storage subsystem capabilities. On user creation ((1)) and deployment ((2), (3), (4)), the system management server picks a volume from the pool and resizes the volume to a user desired size on deployment. As a beneficial result, from the VM user's perspective, the process makes a short cut for prior (2), (3), and (4). Additionally, regarding the pre-creation, the system management server pre-estimates the number of virtual machines to be created based on the current queuing number of deployed VM or velocity of history for the past deployment. As such, the system avoids the lack of the pre-created volume in the pool and provides continuous, uninterrupted VM deployment. This ensures total system reliability under rapid deployment.

In specification embodiments, the management server initiates a request to the storage subsystem to create volumes based on the trend of the number of VM deployment in the recent past. Each of the volumes has a pre-copied image which is copied from a golden image. The golden image has GUID's zero field as disk provider on boot record, file system, OS image or data image. On deployment, the management server changes a volume size of the created volume to a volume size calculated based on a customer wanted or preset specified data image. If the calculated volume size is larger than the storage system supported size, the management server returns an error notice to the user via GUI (graphical user interface). Regarding volume deployment on the OS, the Windows failover cluster assigns a new GUID instead of zero GUID; if the GUID is duplicated among volumes, the Windows failover cluster keeps a state for a duplicated signature disk as the reserved disk.

An aspect of the present invention is directed to a method for deploying virtual machines of one or more host computers which are coupled with a storage subsystem via a network, the storage subsystem providing a pool of pre-created virtual volumes in the storage subsystem prior to deploying the virtual machines, the pre-created virtual volumes having pre-copied images for the virtual machines. The method comprises: selecting one of the pre-created virtual volumes for deploying one of the virtual machines; calculating a volume size for the selected virtual volume based on a specified image size for data and OS image; resizing the selected virtual volume according to the calculated volume size; and requesting one of the host computers to deploy the virtual machine using the resized virtual volume.

In some embodiments, the method further comprises calculating virtual volumes to be added to the pool of pre-created virtual volumes, wherein a number of the pre-created virtual volumes in the pool to be provided per unit time is determined based on a trend of a past number of virtual volumes used in deploying virtual machines per unit time. The method further comprises requesting the storage subsystem to provide the pool of pre-created virtual volumes; and requesting the storage subsystem to copy a virtual machine file to each of the pre-created virtual volumes to produce the pre-copied images for the virtual machines. A golden image is copied to each of the pre-created virtual volumes to produce the pre-copied images for the virtual machines, the golden image including globally unique identifier's zero field as disk provider on boot record, file system, OS image, or data image.

In specific embodiments, the method further comprises, after resizing the selected virtual volume and before deploying the virtual machine using the resized virtual volume: expanding a target partition of the resized virtual volume based on a calculated partition size which is calculated based on the specified image size for data and OS image; resizing a file system of the resized virtual volume based on a calculated file system size which is calculated based on the specified image size for data and OS image; resizing a previously created virtual machine file for the resized virtual volume based on the specified image size for data and OS image; and creating a new virtual machine file, based on the specified image size for data and OS image, to replace the previously created virtual machine file for the resized virtual volume.

In some embodiments, the method further comprises, if the calculated volume size is larger than a maximum size supported by the storage subsystem, then returning an error notice to the user. The volume size, calculated based on the specified image size for data and OS image, includes a sum of: size of MBR, size of partition table, VM configuration size, image file size for OS image and data, margin for VM file for OS image and data, and FS margin; wherein MBR is Master Boot Record, VM is Virtual Machine, OS is Operating System, and FS is File System.

Another aspect of the invention is directed to a management server in an information system for deploying virtual machines of one or more host computers which are coupled with the management server and a storage subsystem via a network, the storage subsystem providing a pool of pre-created virtual volumes in the storage subsystem prior to deploying the virtual machines, the pre-created virtual volumes having pre-copied images for the virtual machines. The management server comprises a processor; a memory; and a volume management module configured to: select one of the pre-created virtual volumes for deploying one of the virtual machines; calculate a volume size for the selected virtual volume based on a specified image size for data and OS image; resize the selected virtual volume according to the calculated volume size; and request one of the host computers to deploy the virtual machine using the resized virtual volume.

In some embodiments, the management server further comprises an OS images pool management module configured to request the storage subsystem to create virtual volumes to be added to the pool of pre-created virtual volumes, wherein a number of the pre-created virtual volumes in the pool to be provided per unit time is determined based on a trend of a past number of virtual volumes used in deploying virtual machines per unit time. The management server further comprises a golden image creator module configured to request the storage subsystem to provide the pool of pre-created virtual volumes; and request the storage subsystem to copy a virtual machine file to each of the pre-created virtual volumes to produce the pre-copied images for the virtual machines.

Another aspect of this invention is directed to a computer-readable storage medium storing a plurality of instructions for controlling a data processor to deploy virtual machines of one or more host computers which are coupled with the management server and a storage subsystem via a network, the storage subsystem providing a pool of pre-created virtual volumes in the storage subsystem prior to deploying the virtual machines, the pre-created virtual volumes having pre-copied images for the virtual machines. The plurality of instructions comprise: instructions that cause the data processor to select one of the pre-created virtual volumes for deploying one of the virtual machines; instructions that cause the data processor to calculate a volume size for the selected virtual volume based on a specified image size for data and OS image; instructions that cause the data processor to resize the selected virtual volume according to the calculated volume size; and instructions that cause the data processor to request one of the host computers to deploy the virtual machine using the resized virtual volume.

These and other features and advantages of the present invention will become apparent to those of ordinary skill in the art in view of the following detailed description of the specific embodiments.

### BRIEF DESCRIPTION OF THE DRAWINGS

FIG. 1 illustrates an example of a hardware configuration of an information system in which the method and apparatus of the invention may be applied.

FIG. 2 illustrates an example of a logical configuration of the invention applied to the architecture of FIG. 1.

FIG. 3 shows an example of the port configuration table.

FIG. 4 shows an example of a flow diagram for creating golden image.

FIG. 5 shows an example of a Master Boot Record.

FIG. 6 shows an example of a Partition Table.

FIG. 7 shows an example of a flow diagram to create VM using storage copy capability.

FIG. 8 shows an example of a flow diagram for VM deployment.

FIG. 9 shows an example of the volume size of a volume illustrating the relationship between VM files.

FIG. 10 shows an example of a procedure of volume size check.

FIG. 11 shows an example of the volume pool management method to provide volumes in the pool continually.

### DETAILED DESCRIPTION OF THE INVENTION

In the following detailed description of the invention, reference is made to the accompanying drawings which form a part of the disclosure, and in which are shown by way of illustration, and not of limitation, exemplary embodiments by which the invention may be practiced. In the drawings, like numerals describe substantially similar components throughout the several views. Further, it should be noted that while the detailed description provides various exemplary embodiments, as described below and as illustrated in the drawings, the present invention is not limited to the embodiments described and illustrated herein, but can extend to other embodiments, as would be known or as would become known to those skilled in the art. Reference in the specification to “one embodiment,” “this embodiment,” or “these embodiments” means that a particular feature, structure, or characteristic described in connection with the embodiment is included in at least one embodiment of the invention, and the appearances of these phrases in various places in the specification are not necessarily all referring to the same embodiment. Additionally, in the following detailed description, numerous specific details are set forth in order to provide a thorough understanding of the present invention. However, it will be apparent to one of ordinary skill in the art that these specific details may not all be needed to practice the present invention. In other circumstances, well-known structures, materials, circuits, processes and interfaces have not been described in detail, and/or may be illustrated in block diagram form, so as to not unnecessarily obscure the present invention.

Furthermore, some portions of the detailed description that follow are presented in terms of algorithms and symbolic representations of operations within a computer. These algorithmic descriptions and symbolic representations are the means used by those skilled in the data processing arts to most effectively convey the essence of their innovations to others skilled in the art. An algorithm is a series of defined steps leading to a desired end state or result. In the present invention, the steps carried out require physical manipulations of tangible quantities for achieving a tangible result. Usually, though not necessarily, these quantities take the form of electrical or magnetic signals or instructions capable of being stored, transferred, combined, compared, and otherwise manipulated. It has proven convenient at times, principally for reasons of common usage, to refer to these signals as bits, values, elements, symbols, characters, terms, numbers, instructions, or the like. It should be borne in mind, however, that all of these and similar terms are to be associated with the appropriate physical quantities and are merely convenient labels applied to these quantities. Unless specifically stated otherwise, as apparent from the following discussion, it is appreciated that throughout the description, discussions utilizing terms such as “processing,” “computing,” “calculating,” “determining,” “displaying,” or the like, can include the actions and processes of a computer system or other information processing device that manipulates and transforms data represented as physical (electronic) quantities within the computer system's registers and memories into other data similarly represented as physical quantities within the computer system's memories or registers or other information storage, transmission or display devices.

The present invention also relates to an apparatus for performing the operations herein. This apparatus may be specially constructed for the required purposes, or it may include one or more general-purpose computers selectively activated or reconfigured by one or more computer programs. Such computer programs may be stored in a computer-readable storage medium, such as, but not limited to optical disks, magnetic disks, read-only memories, random access memories, solid state devices and drives, or any other types of media suitable for storing electronic information. The algorithms and displays presented herein are not inherently related to any particular computer or other apparatus. Various general-purpose systems may be used with programs and modules in accordance with the teachings herein, or it may prove convenient to construct a more specialized apparatus to perform desired method steps. In addition, the present invention is not described with reference to any particular programming language. It will be appreciated that a variety of programming languages may be used to implement the teachings of the invention as described herein. The instructions of the programming language(s) may be executed by one or more processing devices, e.g., central processing units (CPUs), processors, or controllers.

Exemplary embodiments of the invention, as will be described in greater detail below, provide apparatuses, methods and computer programs for rapid deployment of virtual machine pooling volume.

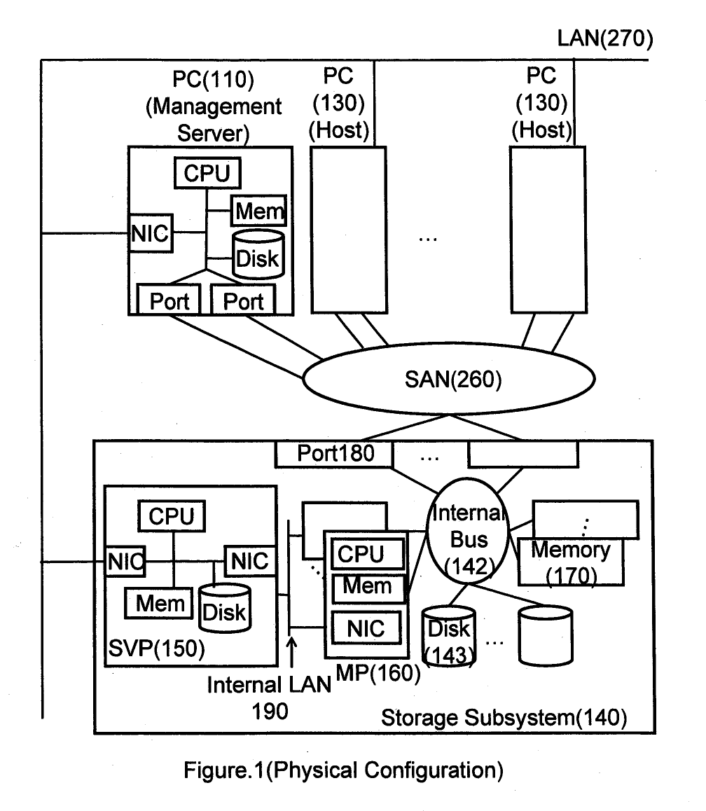

FIG. 1 illustrates an example of a hardware configuration of an information system in which the method and apparatus of the invention may be applied. This system has personal computers (PCs) including a management server 110 and at least one host 130, and a storage subsystem 140. The PCs connect to the storage subsystem 140 via a network 260 such as a SAN (Storage Area Network). The SAN is typically a fiber channel network, and hence includes a Fiber Channel Switch and cables. The SAN may use IP network such as iSCSI. In this case, we use Ethernet cables and Ethernet switch as the network switch. The PCs 110, 130 and storage subsystem 140 are connected by a LAN (Local Area Network) 270. The LAN uses Ethernet network in this embodiment, and it includes Ethernet switch and cables.

Each PC 110, 130 is a general computer, and includes a CPU, a memory, and a disk. It has a Host Bus Adapter (HBA) for storage to connect to the SAN 260. The HBA has a unique identifier in the form of world wide name (WWN). The PC also has a Network Interface Card (NIC) to connect to the LAN 270. The NIC has a MAC address.

The storage subsystem 140 has storage processors (MPs) 160, disks 143, memories 170, ports 180 to connect to the SAN 260, and SerVice Processor (SVP) 150. The ports, MPs, disks, and memories are connected by an internal bus 142. The memory is NVRAM in this embodiment. The port, memory, disk, MP, SVP, and internal bus can be redundant for system reliability. The MP 160 has a CPU, a local memory, and a NIC. Using this NIC, the MP 160 can communicate with the SVP 150. The SVP 150 has two NICs for an internal LAN 190 and the external LAN 270, CPU, memory 170, and disk 143.

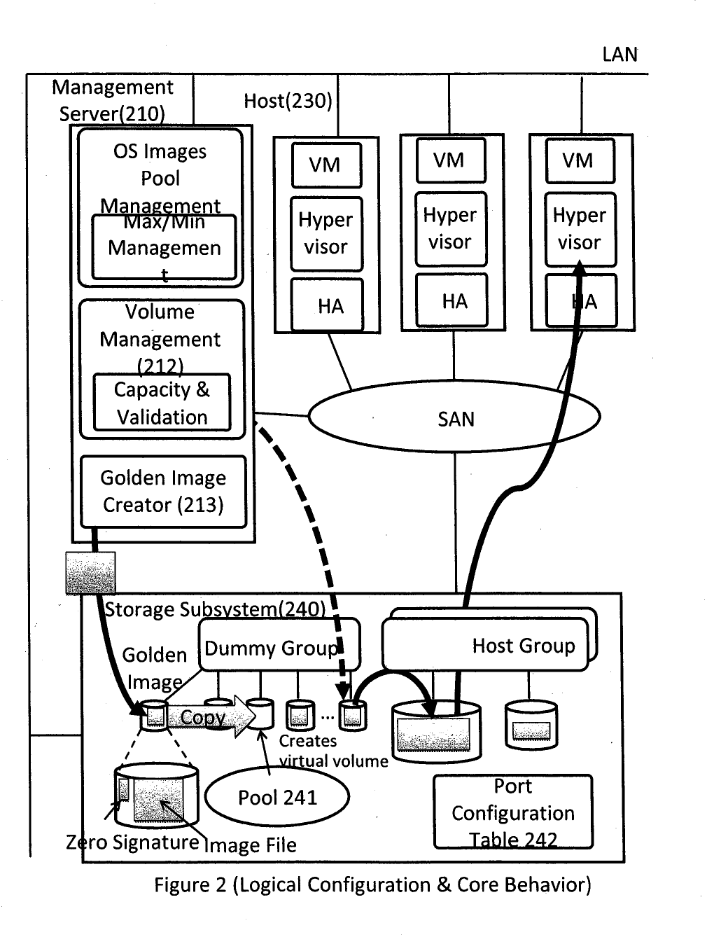

FIG. 2 illustrates an example of a logical configuration of the invention applied to the architecture of FIG. 1. The system has a data center management server or simply management server 210, at least one virtual machine runnable server 230, and the storage subsystem 240. The management server may use the PC 110 in FIG. 1. It has a Web Portal Server (not shown), an OS Images Pool Management module (211), a Volume Management module 212, and a Golden Image Creator 213. The Portal Server represents GUI for the VM administrator or user to create VM and Deploy VM. Based on user's request, the OS Images Pool Management module 211 executes the Deploy Virtual Machine process (Deploy VM process). The Deploy VM process detaches a volume, which is already a copied golden image, from a dummy port, attaches the volume on the host, and discovers the volume on host's OS, and then the VM runnable hypervisor executes the VM on the volume. The golden image is pre-created by a Golden Image Creator 213 based on the schedule of the OS images Pool Management module 211. An original model of a virtual server image having a specific set of software such as OS and application software is prepared as “Gold Image” first, and then multiple snapshots of the “Golden Image” are created as bases of virtual server images. The details of the modules in FIG. 2 are discussed below.

On the hosts 230, there is operating system OS (not shown), hypervisor, and HA (High Availability) software. On the storage subsystem 240, there is a port configuration table 242 and a virtual volume pool 241 as the configuration information. The storage subsystem 240 may be runnable with Thin Provisioning Technology. Based on the port configuration 242, the storage subsystem 240 configures a dummy group on one port and a host group on another port. A host group is a group of hosts which have the host's WWNs that may be mapped to volumes. We discuss later how to configure the ports. On the dummy group, there are several volumes which are golden image and target volumes. On the host group, there are several Host attached volumes. The creation of the target volume from the golden image will be discussed below.

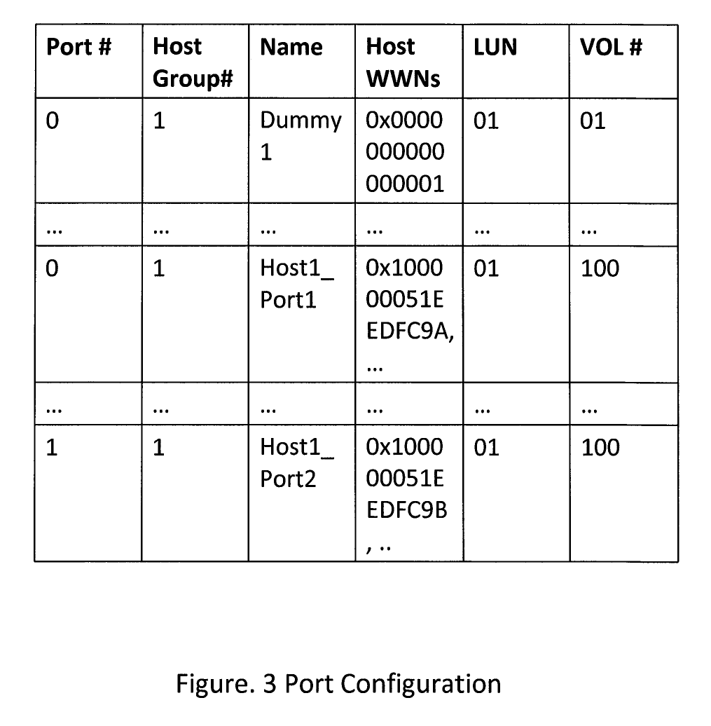

FIG. 3 shows an example of the port configuration table 242. The port configuration table 242 has columns of Port Number, Host Group Number, Name for the Host Group Number, LUN, and V-VOL (Virtual Volume) number. The port identified by the Port Number corresponds to the physical port 180. The Host Group Number (i.e., Host Domain Name in Hitachi products) is on each port to make a group of hosts using the host's world wide name (WWN). The host's WWN is provided by the host's HBA's port in order to specify between the host's port connection and the HBA's port connection. LUNs are on a host group. Therefore, each host group has several LUNs. The LUN is connected to volume (VOL). The VOL number is unique within the storage subsystem. The volume number is shared by several LUNs on different ports' host group to ensure keeping multipath configuration for parallel performance and failover among ports.

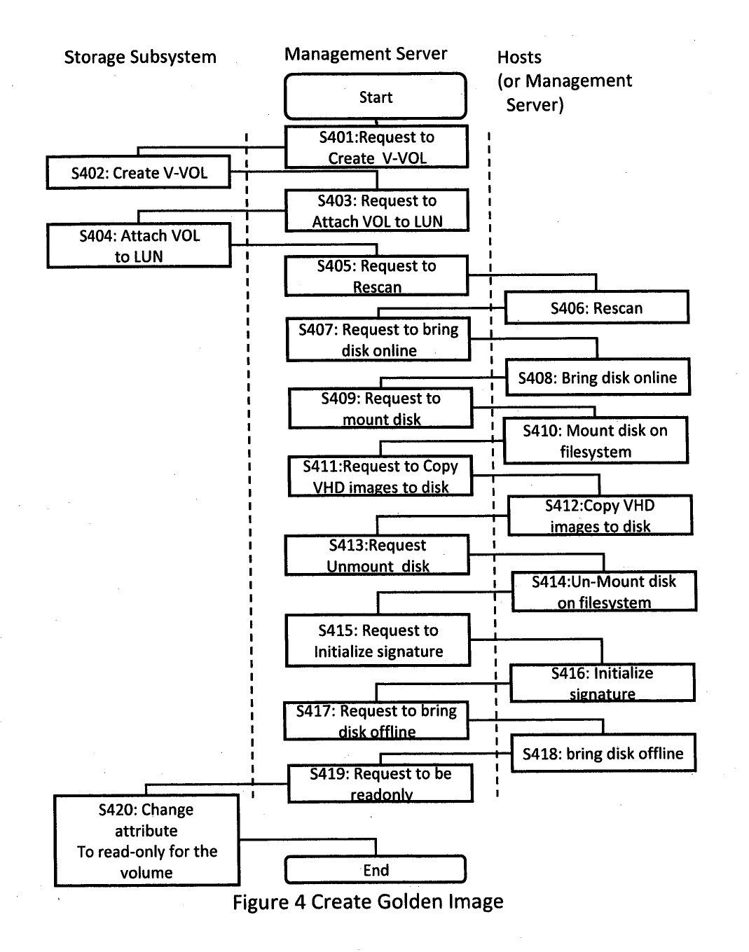

FIG. 4 shows an example of a flow diagram for creating golden image. The process is initiated by the GUI provided by the portal server in the management server 210 and executes on the Golden Image Creator module 213 in the management server 210. The procedure on the management server 210 is described as follows.

In step 401, the management server 210 requests the storage subsystem 240 to create VOL. In step 402, the storage subsystem 240 creates a volume from the storage page pool 241. In step 403, the management server 210 requests the storage subsystem 240 to attach LUN to host on the dummy group. In this embodiment, the LUN is attached to host on dummy group. In other embodiments, another group such as the host group in FIG. 2 may be used instead of the dummy group. In step 404, the storage subsystem 240 attaches VOL to LUN on the dummy group. In step 405, the management server 210 requests the host 230 to rescan volume. In this embodiment, the hosts 230 are used as creator of the management server 210. In other embodiments, the management server is also applicable as creator. In step 406, the management server 210 executes to rescan new disks (term of disk is in OS world name instead of volume) using disk management tools.

In step 407, the management server 210 requests a host 230 to bring a disk online. In OS, the term volume is changed to disk. If the volume is initialized, it may initialize the volume as GPT (GUID Partition Table) or MBR (Master Boot Record) volume and also format the file system on the volume. In step 408, the host 230 executes to bring the disk online. As an example, in Windows, one may bring the disk online using disk management tools. In step 409, the management server 210 requests the host 230 to mount the disk on a mount point. In step 410, the host 230 executes to mount the disk on the mount point using, for instance, a mountvol command. In step 411, the management server 210 copies a Virtual Machine File such as a VHD file to the mounted disk. In step 412, the host 230 executes a procedure to copy the VHD images to the disk. In step 413, the management server 210 requests the host 230 to unmount the disk. In step 414, the host 230 executes to un-mount the disk. In step 415, the management server 210 requests to initialize signature. In step 416, the host 230 initializes signature. This embodiment uses zero. Other embodiments may use other initialization data. In step 417, the management server 210 requests the host 230 to bring the disk offline. In step 418, the host 230 brings the disk (e.g., diskpart's disk) offline. In step 419, the management server 210 requests the storage subsystem 240 to change the attribute to read-only for the volume, which prevents access from the host write.

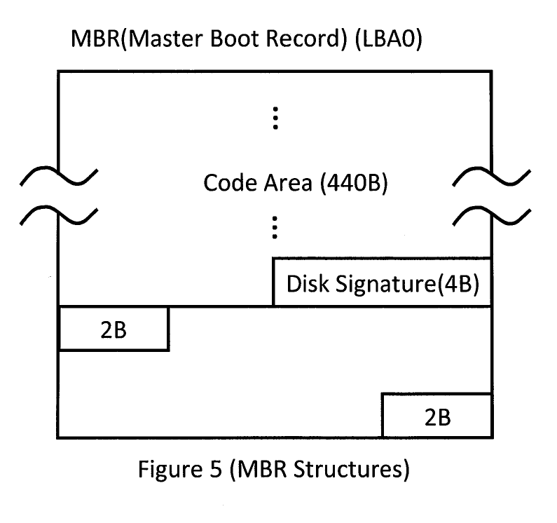

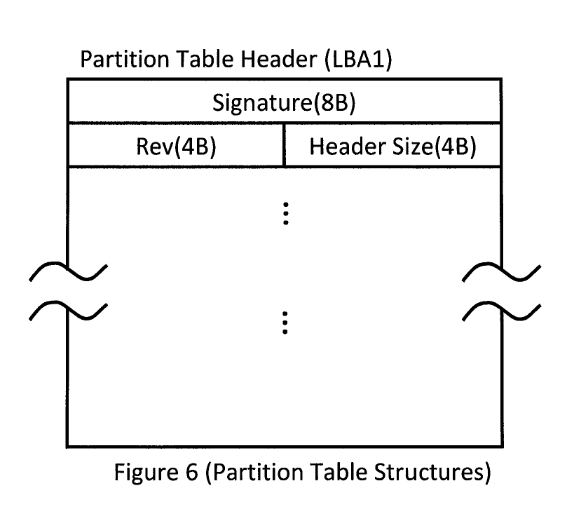

Regarding the process of initializing signature in step 415, FIG. 5 shows an example of a Master Boot Record and FIG. 6 shows an example of a Partition Table. The process initializes signature for disk signature on the MBR in the logical block address 0 in FIG. 5 for the MBR formatted volume. Alternatively, the process initializes signature 8B on the Partition Table Header on LBA 1 in the case of GPT (GUID Partition Table) format. This initialization helps the OS to insert a new signature; otherwise, the HA software reserves the volume which has the same signature volume attached on the same host. To prevent modification of the golden image, step 419 protects the volume from host access as well as storage internal copy operation.

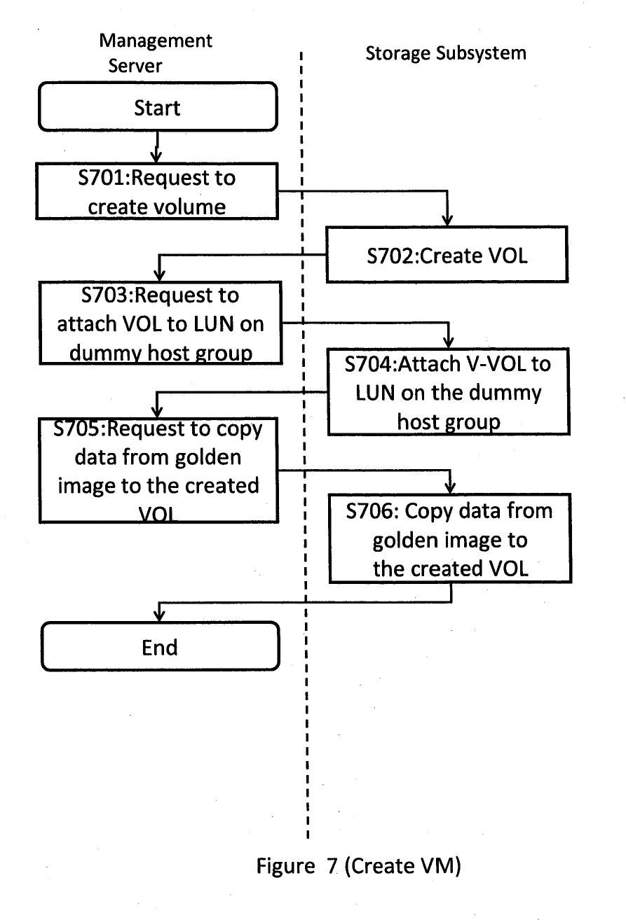

FIG. 7 shows an example of a flow diagram to create VM using storage copy capability. The process is executed on the Volume Management module 212. In step 701, the management server 210 requests the storage subsystem 240 to create a volume. In step 702, the storage subsystem 240 creates a volume from the storage page pool 241. In step 703, the management server 210 requests to attach VOL to LUN on the dummy host group. In step 704, the storage subsystem 240 attaches VOL to LUN on the dummy host group, changing the port configuration table 242. In step 705, the management server 210 requests to copy data from the golden image to the created VOL. In step 706, the storage subsystem 240 executes to copy data from the specified golden image the created VOL.

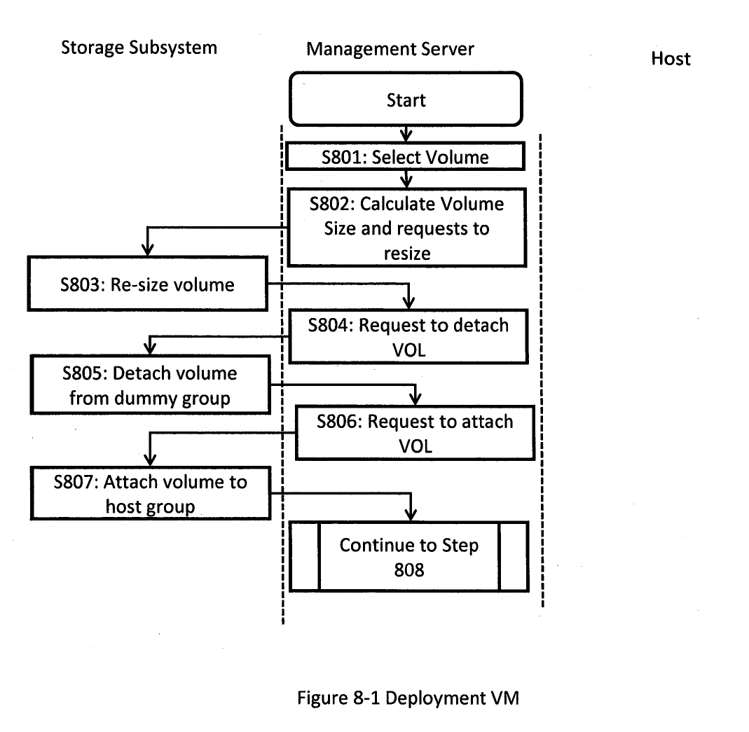

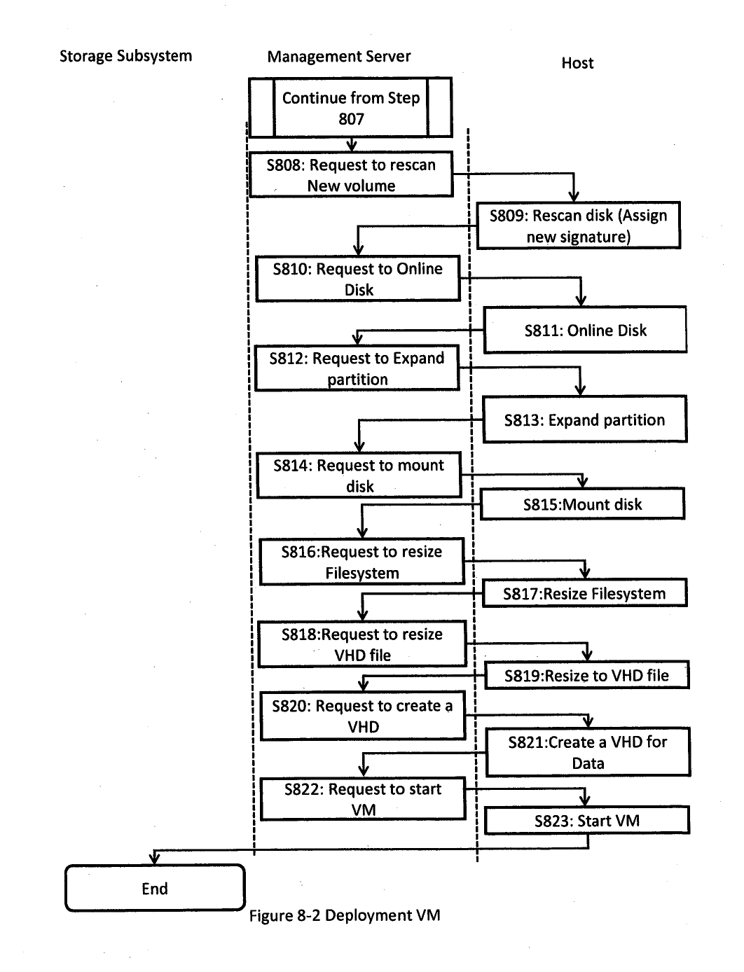

FIG. 8 shows an example of a flow diagram for VM deployment. The VM administrator requests OS imaged volume with specified sizes on VM deployment. The Volume Management module 212, pursuant to received process by the administrator in management software, performs the following steps.

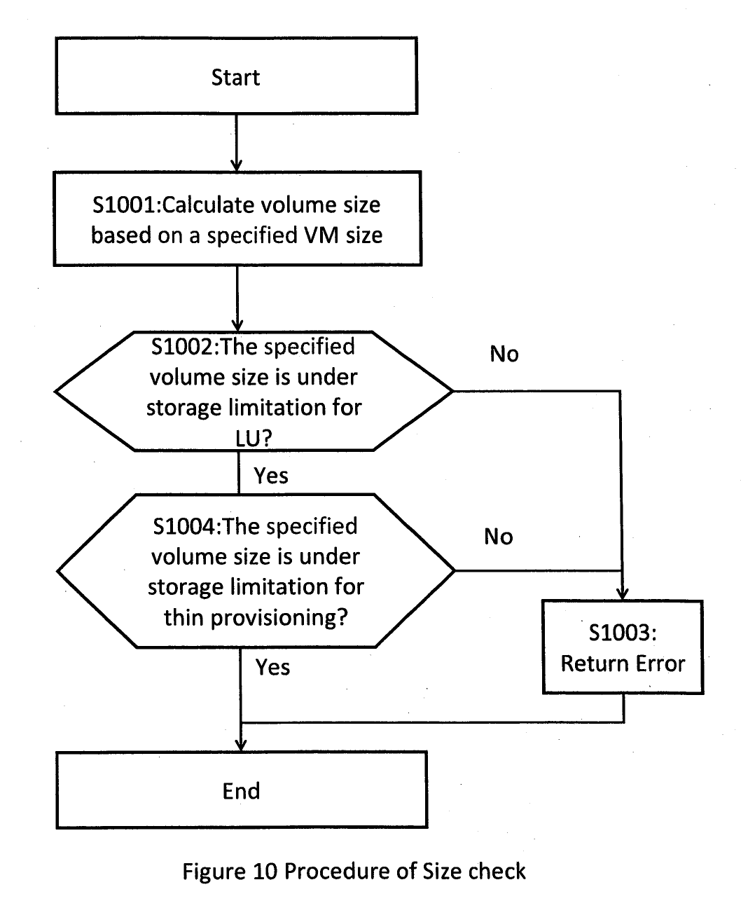

In step 801, the management server 210 selects OS imaged volume which the administrator wants to deploy. In step 802, the management server 210 calculates new volume size based on the user provided or preset VM image size (a.k.a. Image_File_size). The details of this step are discussed below (see FIG.10). The management server 210 requests the storage subsystem 240 to resize the volume. In step 803, the storage subsystem 240 resizes the volume based on the management server's request. In step 804, the management server 210 requests the storage subsystem 240 to detach a target volume from the dummy group. In step 805, the storage subsystem 240 detaches the target volume from the dummy group based on the management server's request. In step 806, the management server 210 requests the storage subsystem 240 to attach the target volume to the target host group. In step 807, the storage subsystem 240 attaches the target volume to the target host group.

In step 808, the management server 210 requests the host's OS to rescan volume so as to discover the target volume on the host. In step 809, the host's OS rescans the disk based on the management server's request to discover the new volume. In sequence, this step executes rescan in diskpart operation and inquires the volume's signature using SCSI page 83 to verify the correct number of the volume. In this step, the OS assigns a new signature to replace the signature initialized in step 416. In step 810, the management server 210 requests the host's OS to bring the disk online disk. In step 811, the host's OS brings the disk online disk. In step 812, the management server 210 requests the host's OS to expand the target partition based on the calculated partition size. The partition size is as follows using the user desired disk size.

$$Partition size = VM\_Configuration \_Size ( 903 ) + Image\_File \_Size ( OS ( 904 ) and Data ( 908 ) ) + Margin\_For \_VM \_File ( OS ( 905 ) and Data ( 909 ) ) … + FS\_Margin ( 906 )$$

The specific Image_File_size is specified by the user from the management server or preset in the management server or provided from the management server before the start of FIG. 8 by the management server.

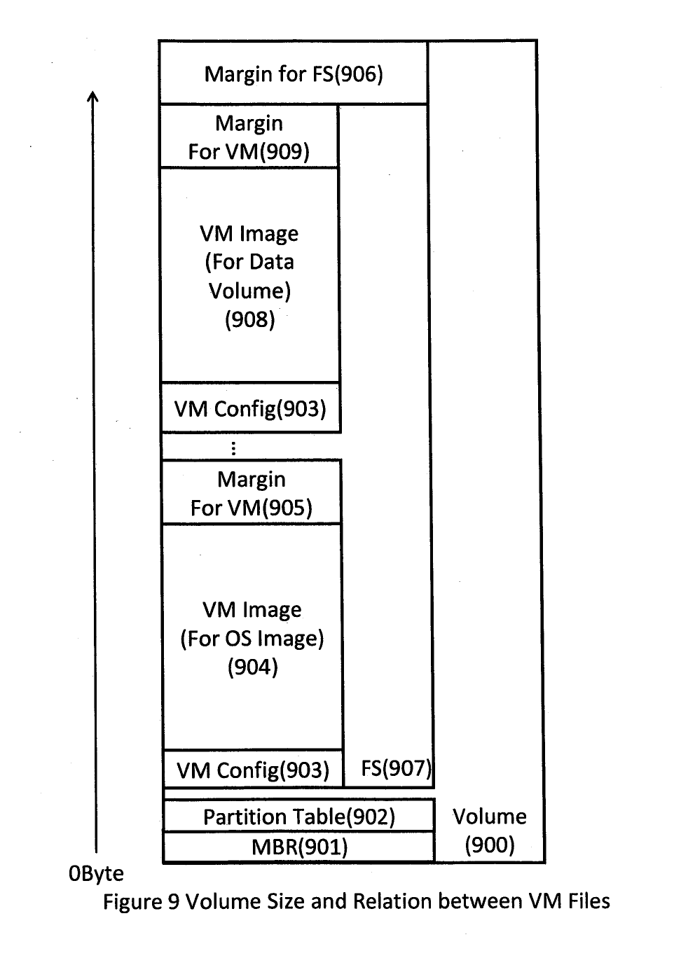

In step 813, the host's OS expand the target partition based requested size. In step 814, the management server 210 requests the host's OS to mount the file system on the partition. In step 815, the host's OS mounts the file system on the partition. In step 816, the management server 210 requests the host's OS to resize the file system based on the calculated file system size (907 in FIG. 9). The file system size includes data volume space. The filesystem size is as the same as the partition one. In step 817, the host's OS resizes the file system based on the requested size from the management server 210. In step 818, the management server 210 requests the host's hypervisor to resize the previously created VHD file based on the user desired or preset disk size (908 in FIG. 9). In step 819, the host's hypervisor resizes the VHD file based on the requested size. In step 820, the management server 210 requests the host's hypervisor to create a VHD file for data disk based on the user desired or preset disk size (908 in FIG. 9). The details of the calculation are discussed below. In step 821, the host's hypervisor creates the VHD file for data disk based on the requested size. In step 822, the management server 210 requests the host's hypervisor to start the VM. In step 823, the host's hypervisor executes to start the VM based on the request from the management server 210.

Regarding the size of the volume in #2 (the storage administrator discovering the created volume), one should consider the size of the metadata for the file system on volume, for the virtual machine's configuration, and for the file system on the VM. FIG. 9 shows an example of the volume size of a volume illustrating the relationship between VM files. The calculation of the volume size is as follows.

$$Total size of volume ( 900 ) = Size\_Of \_MBR ( 901 ) + Size\_Of \_Partition Table ( 902 ) + VM\_Configuration \_Size ( 903 ) + Image\_File \_Size ( OS ( 904 ) and Data ( 908 ) ) + Margin\_For \_VM \_File ( OS ( 905 ) and Data ( 909 ) ) … + FS\_Margin ( 906 )$$

Regarding the margin for VM image (905 or 909), the size is calculated as some percentage (e.g., 5% as normal file system) of the total sum of the VM Configuration or Config 903, for allocating the VM Image as Image_File_Size (904 for OS image or 908 for data volume). Regarding the margin for the FS (File System) 906, the size is calculated by some percentage (e.g., 5% as normal file system) of the total sum of all of the VM Config 903, for allocating the VM Image File (904 or 908). The VM margin helps to provide over-allocation for the OS's file system metadata. Based on VM's image, the management software calculates the size of volume using the total size of volume (900). The management software validates the size of volume to prohibit the provision of LUN by the oversize of the storage subsystem supported. If the user requested size or specified preset size is larger than the hardware limitation (e.g., 2TB per volume), the management server 210 should return an error to the user in process S802 of FIG. 8.

FIG. 10 shows an example of a procedure of volume size check. In step 1001, the management server 210 calculates the size based on the user wanted or preset specific VM Image's filesystem size 900. The input for the calculation is VM Image's filesystem system (see FIG. 9). In step 1002, the management server 210 checks if the specified volume size is under the storage limitation size for the LU (e.g., 2TB). If yes, the management server 210 continues to step 1004. If no, the management server 210 returns an error notice to the user in step 1003. Moreover, if the volume is a thin provisioning volume, the management server 210 inquiries the storage subsystem 240 regarding the total size of allocated total pages, administrator defined maximum capacity of logical unit (this capacity is defined via SVP from administrator), and the threshold to alert the over-provisioning, and it decides if the total size of allocated total pages is under the threshold of administrator defined total capacity or storage vender defined total capacity for thin provisioning in step 1004. If yes, the management server 210 continues to volume creation. If no, the management server 210 returns an error notice to the user on the failure of volume creation in step 1003. By this protection, the customer may create their specified size volume considering the hardware limitation and prevent overuse of the pool in thin provisioning. The benefit of volume size management is that the management server user does not have to recalculate the volume size considering the size of file system, partition table, VM configuration file, and image file (user and data), including the size of FS margin.

Regarding volume pool management, this embodiment should always be ready to provide volumes in the pool. To avoid the situation where the pool is out of available volumes due to a lack of OS imaged volumes, the embodiment manages the pool in an intelligent way. The embodiment presents a method of pool management, especially lower threshold management and hourly creation of VM's number. The OS Images Pool Management module 211 in the management server 210 has a capability to track the total number of deployed volumes and the maximum number of volumes per operation during a certain term (e.g., hourly). Then the OS Images Pool Management module 211 calculates the average number for both numbers.

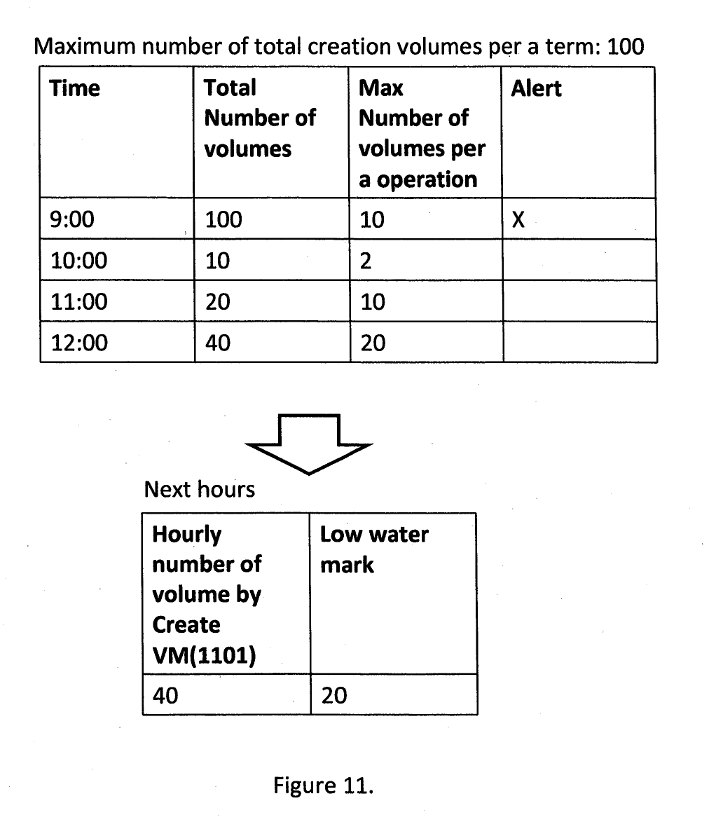

FIG. 11 shows an example of the volume pool management method to provide volumes in the pool continually. In this example, the OS Images Pool Management module 211 executes hourly the Create VM process (FIG. 7) using the hourly number of volume by Create VM 1101 in FIG. 11. If the hourly number of created volume is below the low water marks number, the OS Images Pool Management module 211 tries to execute the Create VM process to prohibit a lack of volumes in the dummy group. In FIG. 11, the hourly number (40) is higher than the low water marks number (20). Using this management scheme, the pool may continually provide OS imaged volumes based on VM administrator usages, i.e., utilizing customer usage time-based monitoring to prohibit the lack of volumes in the dummy group.

According to this embodiment, the VM administrator may deploy user wanted or preset specified sized VM volumes shared by several hosts. Moreover, the VM administrator may improve the availability of the volume pool based on the usage of VM deployment.

Of course, the system configurations illustrated in FIGS. 1 and 2 are purely exemplary of information systems in which the present invention may be implemented, and the invention is not limited to a particular hardware configuration. The computers and storage systems implementing the invention can also have known I/O devices (e.g., CD and DVD drives, floppy disk drives, hard drives, etc.) which can store and read the modules, programs and data structures used to implement the above-described invention. These modules, programs and data structures can be encoded on such computer-readable media. For example, the data structures of the invention can be stored on computer-readable media independently of one or more computer-readable media on which reside the programs used in the invention. The components of the system can be interconnected by any form or medium of digital data communication, e.g., a communication network. Examples of communication networks include local area networks, wide area networks, e.g., the Internet, wireless networks, storage area networks, and the like.

In the description, numerous details are set forth for purposes of explanation in order to provide a thorough understanding of the present invention. However, it will be apparent to one skilled in the art that not all of these specific details are required in order to practice the present invention. It is also noted that the invention may be described as a process, which is usually depicted as a flowchart, a flow diagram, a structure diagram, or a block diagram. Although a flowchart may describe the operations as a sequential process, many of the operations can be performed in parallel or concurrently. In addition, the order of the operations may be rearranged.

As is known in the art, the operations described above can be performed by hardware, software, or some combination of software and hardware. Various aspects of embodiments of the invention may be implemented using circuits and logic devices (hardware), while other aspects may be implemented using instructions stored on a machine-readable medium (software), which if executed by a processor, would cause the processor to perform a method to carry out embodiments of the invention. Furthermore, some embodiments of the invention may be performed solely in hardware, whereas other embodiments may be performed solely in software. Moreover, the various functions described can be performed in a single unit, or can be spread across a number of components in any number of ways. When performed by software, the methods may be executed by a processor, such as a general purpose computer, based on instructions stored on a computer-readable medium. If desired, the instructions can be stored on the medium in a compressed and/or encrypted format.

From the foregoing, it will be apparent that the invention provides methods, apparatuses and programs stored on computer readable media for rapid deployment of virtual machine pooling volume. Additionally, while specific embodiments have been illustrated and described in this specification, those of ordinary skill in the art appreciate that any arrangement that is calculated to achieve the same purpose may be substituted for the specific embodiments disclosed. This disclosure is intended to cover any and all adaptations or variations of the present invention, and it is to be understood that the terms used in the following claims should not be construed to limit the invention to the specific embodiments disclosed in the specification. Rather, the scope of the invention is to be determined entirely by the following claims, which are to be construed in accordance with the established doctrines of claim interpretation, along with the full range of equivalents to which such claims are entitled.

What is claimed is:

1. A method for deploying virtual machines of one or more host computers which are coupled with a storage subsystem via a network, the storage subsystem providing a pool of pre-created virtual volumes in the storage subsystem prior to deploying the virtual machines, the pre-created virtual volumes having pre-copied images for the virtual machines, the method comprising:
selecting one of the pre-created virtual volumes for deploying one of the virtual machines;
calculating a volume size for the selected virtual volume based on a specified image size for data and OS image;
resizing the selected virtual volume according to the calculated volume size; and
requesting one of the host computers to deploy the virtual machine using the resized virtual volume.

2. The method according to claim 1, further comprising:
calculating virtual volumes to be added to the pool of pre-created virtual volumes,
wherein a number of the pre-created virtual volumes in the pool to be provided per unit time is determined based on a trend of a past number of virtual volumes used in deploying virtual machines per unit time.

3. The method according to claim 1, further comprising:
requesting the storage subsystem to provide the pool of pre-created virtual volumes; and
requesting the storage subsystem to copy a virtual machine file to each of the pre-created virtual volumes to produce the pre-copied images for the virtual machines.

4. The method according to claim 3,
wherein a golden image is copied to each of the pre-created virtual volumes to produce the pre-copied images for the virtual machines, the golden image including globally unique identifier's zero field as disk provider on boot record, file system, OS image, or data image.

5. The method according to claim 3, further comprising, after resizing the selected virtual volume and before deploying the virtual machine using the resized virtual volume:
expanding a target partition of the resized virtual volume based on a calculated partition size which is calculated based on the specified image size for data and OS image;
resizing a file system of the resized virtual volume based on a calculated file system size which is calculated based on the specified image size for data and OS image;
resizing a previously created virtual machine file for the resized virtual volume based on the specified image size for data and OS image; and
creating a new virtual machine file, based on the specified image size for data and OS image, to replace the previously created virtual machine file for the resized virtual volume.

6. The method according to claim 1, further comprising:
if the calculated volume size is larger than a maximum size supported by the storage subsystem, then returning an error notice to the user.

7. The method according to claim 1,
wherein the volume size, calculated based on the specified image size for data and OS image, includes a sum of: size of MBR, size of partition table, VM configuration size, image file size for OS image and data, margin for VM file for OS image and data, and FS margin; and
wherein MBR is Master Boot Record, VM is Virtual Machine, OS is Operating System, and FS is File System.

8. A management server in an information system for deploying virtual machines of one or more host computers which are coupled with the management server and a storage subsystem via a network, the storage subsystem providing a pool of pre-created virtual volumes in the storage subsystem prior to deploying the virtual machines, the pre-created virtual volumes having pre-copied images for the virtual machines, the management server comprising:
a processor;
a memory; and
a volume management module configured to
select one of the pre-created virtual volumes for deploying one of the virtual machines;
calculate a volume size for the selected virtual volume based on a specified image size for data and OS image;
resize the selected virtual volume according to the calculated volume size; and
request one of the host computers to deploy the virtual machine using the resized virtual volume.

9. The management server according to claim 8, further comprising:
an OS images pool management module configured to request the storage subsystem to create virtual volumes to be added to the pool of pre-created virtual volumes, wherein a number of the pre-created virtual volumes in the pool to be provided per unit time is determined based on a trend of a past number of virtual volumes used in deploying virtual machines per unit time.

10. The management server according to claim 8, further comprising a golden image creator module configured to:
request the storage subsystem to provide the pool of pre-created virtual volumes; and
request the storage subsystem to copy a virtual machine file to each of the pre-created virtual volumes to produce the pre-copied images for the virtual machines.

11. The management server according to claim 10,
wherein a golden image is copied to each of the pre-created virtual volumes to produce the pre-copied images for the virtual machines, the golden image including globally unique identifier's zero field as disk provider on boot record, file system, OS image, or data image.

12. The management server according to claim 10, wherein the volume management module is configured, after resizing the selected virtual volume and before deploying the virtual machine using the resized virtual volume, to:
expand a target partition of the resized virtual volume based on a calculated partition size which is calculated based on the specified image size for data and OS image;
resize a file system of the resized virtual volume based on a calculated file system size which is calculated based on the specified image size for data and OS image;
resize a previously created virtual machine file for the resized virtual volume based on the specified image size for data and OS image; and
create a new virtual machine file, based on the specified image size for data and OS image, to replace the previously created virtual machine file for the resized virtual volume.

13. The management server according to claim 8, wherein the volume management module is configured to:
if the calculated volume size is larger than a maximum size supported by the storage subsystem, then return an error notice to the user.

14. The management server according to claim 8,
wherein the volume management module is configured to calculate the volume size, based on the specified image size for data and OS image, as including a sum of: size of MBR, size of partition table, VM configuration size, image file size for OS image and data, margin for VM file for OS image and data, and FS margin; and
wherein MBR is Master Boot Record, VM is Virtual Machine, OS is Operating System, and FS is File System.

15. A computer-readable storage medium storing a plurality of instructions for controlling a data processor to deploy virtual machines of one or more host computers which are coupled with the management server and a storage subsystem via a network, the storage subsystem providing a pool of pre-created virtual volumes in the storage subsystem prior to deploying the virtual machines, the pre-created virtual volumes having pre-copied images for the virtual machines, the plurality of instructions comprising:
instructions that cause the data processor to select one of the pre-created virtual volumes for deploying one of the virtual machines;
instructions that cause the data processor to calculate a volume size for the selected virtual volume based on a specified image size for data and OS image;
instructions that cause the data processor to resize the selected virtual volume according to the calculated volume size; and
instructions that cause the data processor to request one of the host computers to deploy the virtual machine using the resized virtual volume.

16. The computer-readable storage medium according to claim 15, wherein the plurality of instructions further comprise:
instructions that cause the data processor to request the storage subsystem to create virtual volumes to be added to the pool of pre-created virtual volumes, wherein a number of the pre-created virtual volumes in the pool to be provided per unit time is determined based on a trend of a past number of virtual volumes used in deploying virtual machines per unit time.

17. The computer-readable storage medium according to claim 15, wherein the plurality of instructions further comprise:
instructions that cause the data processor to request the storage subsystem to provide the pool of pre-created virtual volumes; and
instructions that cause the data processor to request the storage subsystem to copy a virtual machine file to each of the pre-created virtual volumes to produce the pre-copied images for the virtual machines.

18. The computer-readable storage medium according to claim 17,
wherein a golden image is copied to each of the pre-created virtual volumes to produce the pre-copied images for the virtual machines, the golden image including globally unique identifier's zero field as disk provider on boot record, file system, OS image, or data image.

19. The computer-readable storage medium according to claim 17, wherein the plurality of instructions further comprise instructions that cause the data processor, after resizing the selected virtual volume and before deploying the virtual machine using the resized virtual volume, to:
expand a target partition of the resized virtual volume based on a calculated partition size which is calculated based on the specified image size for data and OS image;
resize a file system of the resized virtual volume based on a calculated file system size which is calculated based on the specified image size for data and OS image;
resize a previously created virtual machine file for the resized virtual volume based on the specified image size for data and OS image; and
create a new virtual machine file, based on the specified image size for data and OS image, to replace the previously created virtual machine file for the resized virtual volume.

20. The computer-readable storage medium according to claim 15, wherein the plurality of instructions further comprise:
instructions that cause the data processor, if the calculated volume size is larger than a maximum size supported by the storage subsystem, to return an error notice to the user.
